(19) United States
(12) Patent Application Publication
(10) Pub. No.: US 2005/0083020 A1
(43) Pub. Date: Apr. 21, 2005

(54) Electrostatic charge storage assembly

(76) Inventor: David W. Baarman, Fennville, MI (US)

Correspondence Address: ALTICOR INC., 7575 FULTON STREET EAST MAILCODE 78-2G, ADA, MI, 49355, US

(21) Appl. No.: 10/689,154

(22) Filed: Oct. 20, 2003

(51) Int. Cl. H01M 6/50

(52) U.S. Cl. 320/166

(57) ABSTRACT

An electrostatic charge storage assembly having capacitor and a discharge regulator is provided. In one embodiment, the electrostatic charge storage assembly further includes an inductive charging circuit operative to charge the capacitor. In another embodiment, the electrostatic charge storage assembly further includes a charge regulator. In a further embodiment, the electrostatic charge storage assembly of the present invention is adapted to be removably inserted within a battery housing of an electronic device. In a further embodiment, the electrostatic charge storage assembly of the present invention is adapted to fit within a housing, said housing being of the same or smaller dimensions of one or more standard or non-standard primary or secondary batteries.

### TECHNICAL FIELD

This invention relates generally to power supplies, and more specifically to an electrostatic charge storage assembly for use as a rechargeable supply of electricity.

### INCORPORATION BY REFERENCE

This application hereby incorporates in its entirety by reference issued U.S. Pat. No. 6,436,299 entitled “Water Treatment System With An Inductively Coupled Ballast” to Baarman et al. This application also hereby incorporates in their entirety by reference pending U.S. patent application Ser. No. 10/133,860 entitled “Inductively Powered Lamp Assembly” to Baarman, pending U.S. patent application Ser. No. 10/357,932 entitled “Inductively Powered Apparatus” to Baarman et al, pending U.S. patent application Ser. No. 10/246,155 entitled “Inductively Coupled Ballast Circuit” to Kuennen et al, pending U.S. patent application Ser. No. ______ entitled “Inductive Coil Assembly” to Baarman, and pending U.S. patent application Ser. No. ______ entitled “Adaptive Inductively Coupled Ballast Circuit” to Baarman.

### BACKGROUND OF THE INVENTION

Electrical energy storage devices have been in use throughout the world for decades. Wet cell and dry cell batteries are used to provide electricity for many diverse products, including boats, automobiles, aircraft, radios, games, toys, computers, personal digital assistants (PDA's), televisions, clocks, flashlights, and a host of other electric and electronic devices. These batteries are useful and pervasive, in part, because they provide a portable, and often rechargeable supply of electricity.

Wet cell and dry cell batteries, while useful, offer distinct disadvantages. Both are often comprised of hazardous, and even toxic chemicals, requiring care and specialized facilities when handling and disposing of these batteries. These batteries are also susceptible to corrosion or mechanical failure, resulting in the release of the hazardous and toxic materials within, and exposing both the user and the environment to potential injury.

Another disadvantage to some batteries, referred to as “primary” batteries, is that they are capable of being discharged only once. Once discharged, the primary battery is often discarded.

Another disadvantage to some batteries, referred to as “secondary” batteries, is that they may provide only a limited number of charge-discharge cycles. As a result, the user is required to replace and dispose of the used batteries after this number of charge-discharge cycles has been met. In addition, the equipment used to recharge these batteries require direct physical contact between the battery and the charger. The exposed leads of the battery charger can present a hazard to the user, and can render the charger susceptible to mechanical damage or damage from the environment.

Another disadvantage to these batteries is that they require a relatively long period of time to fully recharge. A further disadvantage to these batteries is that they can develop a charge “memory”, resulting in a decrease over time of the amount of usable stored charge.

The recharging of wet cell batteries is further inhibited if the batteries are left in the discharged state for only a very few days, or used at too high a temperature, or used with too high an acid concentration, or if a small discharge current is drawn for a long time. Another drawback to the wet-cell battery is that these batteries generate hydrogen gas when recharging, resulting in a potential fire or explosion risk to the user of these batteries.

The use of electrostatic charge storage devices, such as a capacitors, supercapacitors, aerogel supercapacitors, or ultracapacitors to provide electric power is also known. A capacitor stores an electrostatic charge by accumulating charges on two electrodes when a potential is applied. Capacitors are capable of providing high energy densities and a very high number of discharge-charge cycles. Capacitors are also able to be quickly charged, and do not develop a charge “memory”. One disadvantage offered by capacitors is that they can be damaged or destroyed if exposed to excessive charge voltage. Another disadvantage of capacitors is that they rapidly discharge, often linearly, making them impracticable for use as an energy storage device for use in electric or electronic devices that require a substantially uniform power supply over a relatively long period of time.

These, and other deficiencies, are overcome by the present invention.

### SUMMARY OF THE INVENTION

The foregoing deficiencies and other problems presented by conventional batteries and other electric charge storage devices are resolved by the electrostatic charge storage assembly of the present invention.

In one embodiment of the present invention, an electrostatic charge storage device such as a capacitor, a supercapacitor, an ultracapacitor, or an aerogel capacitor, or other electrostatic charge storage devices known in the art, hereinafter collectively referred to as “capacitor” or “capacitors”, is electrically coupled with a discharge regulator that is used to maintain a constant voltage supply from the capacitor during at least part of the capacitor discharge cycle. According to this embodiment, the capacitor can be quickly charged using charging circuits or devices known to those skilled in the art. The charged capacitor and discharge regulator are then coupled with a load, thereby providing a source of electric power for the load.

In another embodiment of the present invention, an inductive charging circuit is used to inductively charge an electrostatic charge storage device such as a capacitor. Although not widely available, inductively coupled systems are known. A conventional inductively coupled system generally includes a primary circuit having a primary coil (or “primary”) that is driven by a power supply and a secondary circuit having a secondary coil (or “secondary”) that inductively receives power from the primary and provides that power to a load. One example of an inductively coupled system is found in U.S. Pat. No. 6,436,299 to Baarman et. al. entitled “Water Treatment System with an Inductively Coupled Ballast”, the subject matter of which is incorporated in its entirety by reference. The capacitor is coupled with a discharge regulator. The discharge regulator regulates the discharge of the electrostatic charge storage device to an coupled load. It would be obvious to those skilled in the art that many inductive power supply circuits could be used in conjunction with this and other embodiments of the present invention. Example of several such power supply circuits include, but are not limited to, those disclosed in pending U.S. patent application Ser. No. 10/246,155 to Baarman et. al. entitled “Inductively Coupled Ballast Circuit”, the subject matter of which is incorporated by reference in its entirety.

In another embodiment of the present invention, a capacitor is coupled with a charging circuit. The capacitor is also coupled with a discharge regulator that is used to maintain a constant voltage from the capacitor to a load during at least part of the capacitor discharge cycle. The discharge regulator and the capacitor are also coupled with a load or to load contacts.

In another embodiment of the present invention, a capacitor is coupled with a charge regulator used to regulate the charge to the capacitor. The charge regulator is coupled with a charging circuit. The capacitor is also coupled by a discharge regulator to a load or load contacts.

In another embodiment of the present invention, a plurality of capacitors are coupled in series to a charge regulator. The charge regulator is coupled with a charging circuit. The capacitors are also coupled with a discharge regulator that is used to maintain a constant voltage from the capacitors to a load during at least part of the capacitor discharge cycle.

In another embodiment of the present invention, a plurality of capacitors are coupled in parallel. Said plurality of capacitors may be coupled by one or more charge regulators with a charging circuit. The capacitors are also coupled with one or more discharge regulators used to maintain a constant voltage from the capacitors to a load during at least part of the capacitor discharge cycle.

In a another embodiment, the electrostatic charge storage assembly of the present invention is adapted to be removably inserted within a battery housing of an electronic device.

In a further embodiment, the electrostatic charge storage assembly of the present invention is adapted to fit within a housing, said housing being of the same or smaller dimensions of one or more standard or non-standard primary or secondary batteries, such as an alkaline, carbon-zinc, nickel metal hydride (NiMH) nickel cadmium (NiCAD), lithium ion, or other known batteries. According to this embodiment of the present invention, the housing is adapted to be removably inserted within an electric or electronic device and enable coupling between the charge storage device and said electric or electronic device. According to this embodiment, the electrostatic charge storage assembly of the present invention can optionally function as a replacement for one or more standard or non-standard primary or secondary batteries, including, but not limited to, AAAA, N, ⅓A, AAA, AA, C, D, F, G, J, F3 Prismatic, 9 Volt transistor radio style, 6 volt “908” lantern, and 6 volt “918” lantern batteries.

These and other objects, advantages, and features of the invention will be readily understood and appreciated by reference to the detailed description of the invention and the drawings.

### BRIEF DESCRIPTION OF THE DRAWINGS

FIG. 1 is a block diagram for one embodiment of the electrostatic charge storage assembly.

FIG. 2 is a schematic for one embodiment of the electrostatic charge storage assembly.

FIG. 3 is a schematic for one embodiment of the electrostatic charge storage assembly.

FIG. 4 is a schematic for one embodiment of the electrostatic charge storage assembly.

FIG. 5 is a schematic for one embodiment of the electrostatic charge storage assembly.

FIG. 6 is an exploded perspective view for one embodiment of the present invention.

### DETAILED DESCRIPTION OF THE ILLUSTRATED EMBODIMENT

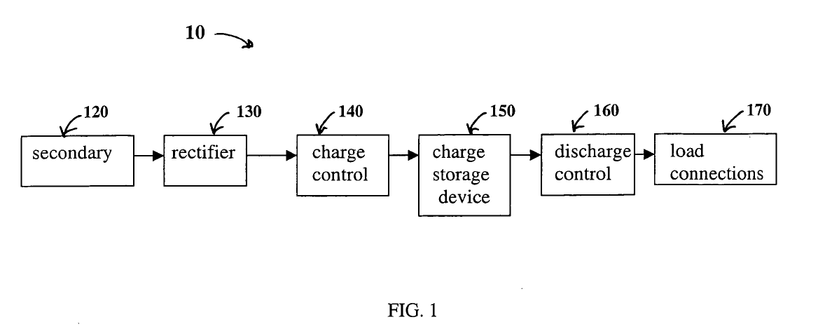

Referring to FIG. 1, one embodiment of electrostatic charge storage assembly 10 of the present invention includes a secondary 120 which inductively receives an alternating current (AC) signal from the primary (not shown) of a power supply (not shown). Secondary 120 is coupled with rectifier 130. Rectifier 130 is coupled with charge storage device 150 and, optionally, charge control 140. Rectifier 130 converts the AC signal received by secondary 120 to a direct current (DC) signal as described in more detail below. Charge control 140 influences the charging of charge storage device 150 as described in more detail below. Charge storage device 150 is coupled with discharge control 160 and to load connections 170. Discharge control 160 and influences the discharge of charge storage device 150 to a load coupled with load connections 170, as described more fully below. It would be obvious to those skilled in the art that a non-inductive charging system could be used in addition to, or in place of, the inductive charging system as shown in this and other embodiments.

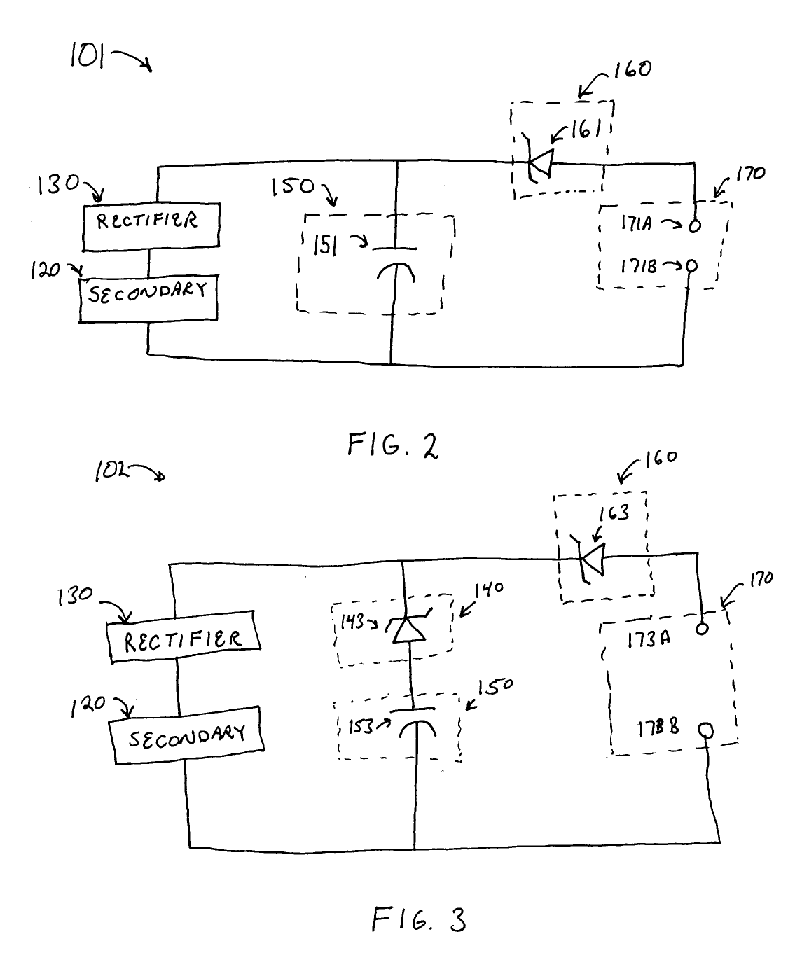

With further reference to FIG. 2, one embodiment of electrostatic charge storage assembly 101 is shown in detail. Secondary 120 is coupled by rectifier 130 to charge storage device 150, discharge regulator 160, and load connection 171B. It would be appreciated by one skilled in the arts that, throughout this document, the term “secondary” refers preferably to a coil or a plurality of coils of small diameter wire. The precise characteristics of the secondary will vary from application to application as a function of the primary (not shown) and of a power supply (not shown), and of the load (not shown) attached to load connections 171A/B. Secondary 120 is preferably comprised of conventional magnet or LITZ wire depending on the power and heat dissipation requirements of the present invention or of the load (not shown). It would also be appreciated by one skilled in the art that rectifier 130 could be comprised of any electronic device, such as a semiconductor diode or rectifier or plurality of diodes or rectifiers, that convert the alternating current from secondary 120 to a direct current by suppression or inversion of alternate half cycles. It would also be appreciated by one skilled in the arts that secondary 120 could be comprised of two or more coils oriented at different angles with respect to each other, and that rectifier 130 could be correspondingly comprised of two or more diodes or rectifiers operable to convert the alternating current from secondary 120 into a direct current. Examples of secondary and rectifier circuits that could be used with the electrostatic charge storage assembly of the present invention include, but are not limited to, those disclosed in U.S. patent application Ser. No. 10/133,860 to Baarman, entitled “Inductively Powered Lamp Assembly”, and U.S. patent application Ser. No. ______ entitled “Inductive Coil Assembly” to Baarman, the subject matter of which are both hereby incorporated in their entirety by reference.

With further reference to FIG. 2, charge storage device 150 is comprised of capacitor 151. It would be appreciated by one skilled in the art that, throughout this document, the term “capacitor” refers to a capacitor, supercapacitor, aerogel supercapacitor, ultracapacitor, or any other equivalent device used for the storage of an electrostatic charge. It would also be appreciated by those skilled in the art that charge storage device 150 could be comprised of two or more capacitors in parallel or in series, or in combination of parallel and series, as discussed below.

With further reference to FIG. 2, discharge regulator 160 is comprised of zener diode 161. Although shown as a zener diode in this and other embodiments, it would be appreciated by one skilled in the art that, throughout this document, discharge regulator 160 could be comprised of any voltage regulating devices capable of maintaining a constant voltage across load contacts 171A and 171B during at least a portion of the discharge cycle of charge storage device 150.

According to the embodiment shown in FIG. 2, and to some other embodiments discussed below, placing secondary 120 within an electromagnetic field generated by a primary (not shown) induces an alternating current through secondary 120, which is rectified by rectifier 130 and charges charge storage device 150. According to this embodiment of the present invention, zener diode 161 regulates the discharge of capacitor 151 to a load (not shown) coupled with load connections 171A/B. In particular, zener diode 161 regulates the discharge rate of capacitor 151 to a load (not shown) coupled with load connections 171A/B so that the discharge rate of capacitor 151 substantially emulates the discharge rate of a battery. According to this and some other embodiments of the present invention, the DC output from secondary 120 and rectifier 130 can also directly power a load (not shown) coupled with load connections 171A/B.

With reference to FIG. 3, another embodiment 102 of the present invention is shown in detail. Secondary 120 is coupled by rectifier 130 to charge regulator 140. Charge regulator 140 is coupled with charge storage device 150 and discharge regulator 160. Charge storage device 150 includes capacitor 153. Charge regulator 140 includes zener diode 143, and discharge regulator 160 includes zener diode 163. According to this embodiment, zener diode 143 prevents over-voltage of capacitor 153. Although shown as a zener diode in this embodiment, it would be appreciated by one skilled in the art that charge regulator 140 could be comprised of any voltage regulating device capable of maintaining a substantially constant voltage to charge storage device 150 as the charge from a charging circuit varies. According to this embodiment, zener diode 163 regulates the discharge of capacitor 153 to a load (not shown) coupled with load connections 173A/B.

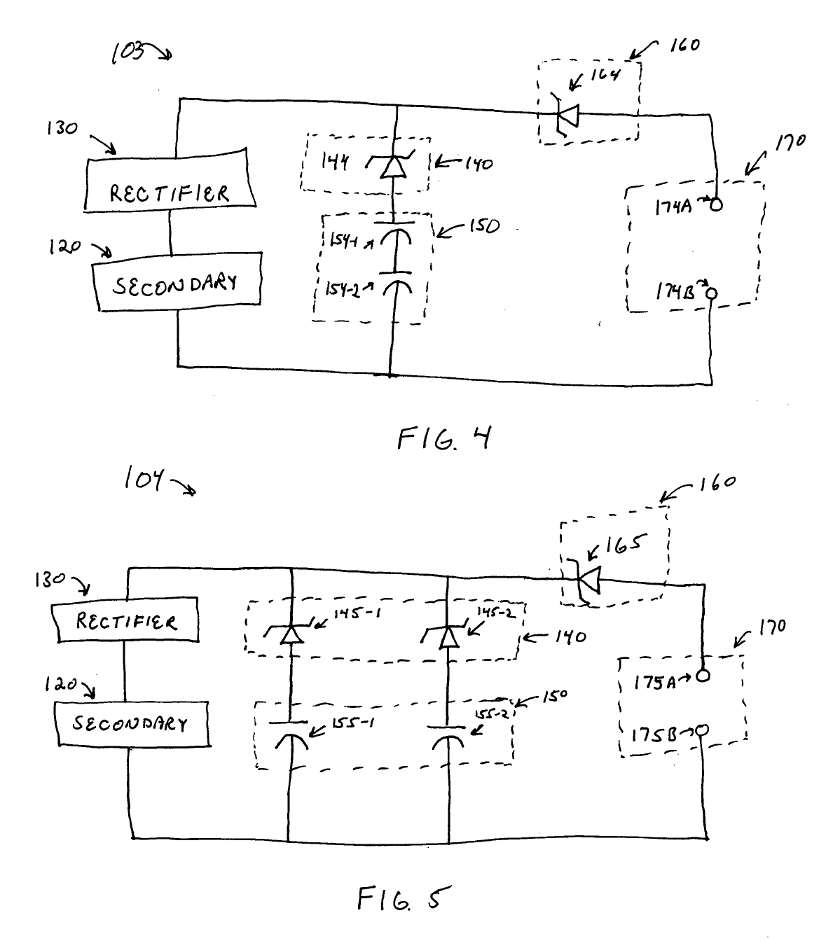

With reference to FIG. 4, another embodiment 103 of the present invention is shown in detail. Charge storage device 150 is comprised of capacitors 154-1 and 154-2. Although shown with two capacitor in series, one of ordinary skill in the art would recognize that two or more capacitors of the same or differing voltage or capacitance ratings could also be used in series depending on the working voltage of the load (not shown) and the operating voltage rating of each capacitor. Charge regulator 140 is comprised of zener diode 144, and discharge regulator 160 is comprised of zener diode 164. As in the previous embodiments, zener diode 144 regulates the charge to capacitors 154-1 and 154-2, and zener diode 164 regulates the discharge of capacitors 154-1 and 154-2 to a load (not shown) coupled with load connections 170A/B.

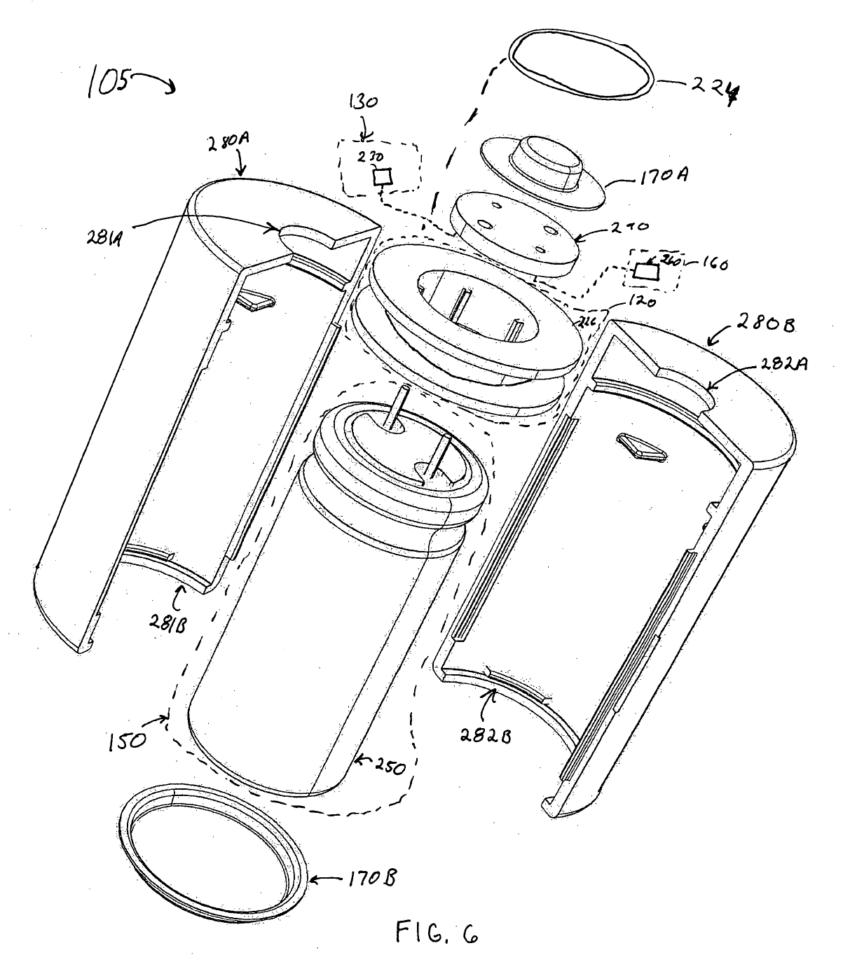

With reference to FIG. 5, another embodiment 104 of the present invention is shown in detail. Charge storage device 150 is comprised of capacitors 155-1 and 155-2. Although shown with two capacitors in parallel, one of ordinary skill in the art would recognize that two or more capacitors of the same or differing voltage or capacitance ratings could also be used in parallel depending on the working current of the load (not shown) and the operating current or capacitance of each capacitor. Charge regulator 140 is comprised of zener diode 145-1 and 145-2. Discharge regulator 160 is comprised of zener diode 165. According to this embodiment of the present invention, zener diodes 145-1 and 145-2 regulate the charge to capacitors 155-1 and 155-2 respectively, and zener diode 165 regulates the discharge of capacitors 155-1 and 155-2 to a load (not shown) coupled with load connections 175A/B.

Although the present invention is illustrated with several specific embodiments, many combinations of series and parallel configurations for the charge control 130, charge storage device 150, and discharge control 160, would be obvious to those skilled in the art. One of ordinary skill in the art would also recognize that many charging systems could be used with the electrostatic charge storage assembly of the present invention.

According to some embodiments of the present invention, voltage values for charge storage device 150, discharge regulator 160, and load 170 are calculated substantially as follows:
V_{d}=V_{c}−Vₗ
V_{c}(min)=2*Vₗ
Where
   V_{d}=Discharge Regulator 160 voltage rating
   V_{c}=Charge storage device 150 voltage rating
   Vₗ=Load 170 voltage rating
   V_{c}(min)=Charge storage device 150 minimum voltage rating.

With further reference to FIG. 6 another embodiment 105 of the present invention is shown in detail. According to this embodiment, electrostatic charge storage assembly 105 is contained within housing sections 280A and 280B. Housing sections 280A and 280B are provided with a plurality of apertures 281A/B and 282A/B, to allow load contacts 170A and 170B to protrude therethrough. Secondary 120 is comprised of secondary coil 224 wrapped around bobbin 226. Although shown as a single primary coil, it would be obvious to those skilled in the art that multiple secondary's could be used. Secondary coil 224 is coupled with load connection 170B and charge storage device 150. Secondary 120 is further coupled with rectifier 130. According to this embodiment, rectifier 130 is comprised of diode 230 mounted on circuit board 290. Rectifier 130 is further coupled with charge storage device 150 and discharge control 160. Charge storage device 150 is comprised of capacitor 250, and discharge control 160 is comprised of zener diode 260 mounted on circuit board 290. Discharge control 160 is further electrically coupled with load contact 170A. Although housing sections 280A/B are shown as cylindrical, it would be obvious to one skilled in the art that housing sections 280A/B could be square, rectangular, prismatic, or other geometric shape to facilitate coupling between electrostatic charge storage assembly 105 and one or more electric or electronic devices. It would also be obvious to those skilled in the art that many configurations of the electrostatic charge storage assembly 105 of the present, including those specifically discussed and referred to above, are adaptable to fit within the battery housings of electric or electronic devices as discussed above, thereby providing removably insertable rechargeable electric power supply for a wide range of electric or electronic devices.

While in the foregoing specification this invention has been described in relation to certain preferred embodiments thereof, and many details have been set forth for the purpose of illustration, it will be apparent to those skilled in the art that the invention is susceptible to alteration and that certain other details described herein can vary considerably without departing from the basic principles of the invention.

1. An electrostatic charge storage assembly comprised of:
a capacitor; and
a discharge regulator coupled with the capacitor.

2. The electrostatic charge storage assembly of claim 1 further comprising a plurality of load connections.

3. The electrostatic charge storage assembly of claim 1, wherein the discharge regulator regulates the discharge rate of the capacitor to a load coupled with the load connections so that the discharge rate substantially emulates the discharge rate of a battery.

4. The electrostatic charge storage assembly of claim 3 wherein the discharge regulator is a zener diode.

5. The electrostatic charge storage assembly of claim 1 wherein the capacitor is a supercapacitor.

6. The electrostatic charge storage assembly of claim 1, wherein the capacitor is an aerogel supercapacitor.

7. The electrostatic charge storage assembly of claim 1, further comprising:
a charging circuit.

8. The electrostatic charge storage assembly of claim 7, wherein the charging circuit is an inductively coupled charging circuit operable to charge the capacitor.

9. The electrostatic charge storage assembly of claim 8, wherein the inductively coupled charging circuit is comprised of a plurality of secondary coils.

10. The electrostatic charge storage assembly of claim 7 further comprising a charge regulator coupled with the capacitor.

11. The electrostatic charge storage assembly of claim 10, wherein the charge regulator is a zener diode.

12. An electrostatic charge storage assembly comprised of:
a plurality of capacitors; and
a discharge regulator coupled with at least one of the capacitors.

13. The electrostatic charge storage device of claim 12 where the discharge regulator controls the plurality of capacitors so that the discharge rate of the plurality of capacitors substantially emulates the discharge rate of a battery.

14. The electrical discharge storage device of claim 13 where the discharge regulator is a zener diode.

15. The electrical charge storage assembly of claim 13 wherein the capacitors are electrically coupled in a series configuration.

16. The electrical charge storage assembly of claim 13 wherein the capacitors are electrically coupled in a parallel configuration.

17. The electrical charge storage assembly of claim 13 wherein the capacitors are electrically coupled in a combination series and parallel configuration.

18. A self-contained rechargeable electrostatic charge storage assembly comprising:
a charge storage device comprising one or more capacitors;
a charging circuit;
a charge control coupled to the charging circuit and the charge storage device;
a discharge control coupled with the charge storage device;
a first contact coupled with the charging circuit;
a second contact coupled with the discharge control circuit; and
a housing substantially containing the first contact, the second contact, the discharge control, the charge control, the charging circuit, and the charge storage device, said housing further having a plurality of apertures operable to expose the first contact and the second contact to therethrough.

19. The self-contained rechargeable charge storage device of claim 18 wherein the charging circuit is an inductively coupled charging circuit.

20. The self-contained rechargeable charge storage device of claim 19 wherein the inductively coupled charging circuit is comprised of a plurality of secondary coils.

21. A method for providing power to an electronic device, the method comprising:
charging an electrostatic charge storage device;
controlling the discharge of the electrostatic charge storage device to substantially emulate the discharge of a battery.

22. The method of claim 21, wherein the charging is inductive charging.
